(19) United States
(12) Patent Application Publication
(10) Pub. No.: US 2010/0064246 A1
(43) Pub. Date: Mar. 11, 2010

(54) METHOD AND SYSTEM FOR INTERFACING AND DISSEMINATION OF ELECTION-RELATED INFORMATION

(76) Inventor: Scott Gluck, La Canada, CA (US)

Correspondence Address: Ostrow Kaufman & Frankl LLP;Susan Formicola, The Chrysler Building, 405 Lexington Avenue, 62nd Floor, NEW YORK, NY, 10174, US

(21) Appl. No.: 12/208,778

(22) Filed: Sep. 11, 2008

(51) Int. Cl. G06F 3/00

(52) U.S. Cl. 715/779

(57) ABSTRACT

The present invention provides a method and system for computerized interfacing and dissemination of election-related information. The method and system includes presenting, via a networked connection, a political engagement map that includes a visual interface display of at least one geographic area. The method and system includes receiving a region selection command relative to the political engagement map and retrieving election-specific information associated with a geographic region indicated by the region selection command. The method and system includes updating the political engagement map to display the geographic region and the election-specific information associated with the geographic region and receiving an election information request via a toolbar interface displayed relative to the political engagement map. The method and system includes, in response to the election information request, accessing an election information database to retrieve election information and updating an output display with the retrieved election information.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF INVENTION

The present invention relates generally to an electronic interface and information dissemination and more specifically to providing an electronic interface and information dissemination, as well as related processing architecture, relating to election and voting information.

### BACKGROUND OF THE INVENTION

With the growth of computing systems and various interfacing advancements, one area having not achieved significant development relates to voting and election information. Existing interfacing techniques of simple data entry and data retrieval fail to support the user, in part because of the specialized nature of election information.

For example, an existing interface may be typical web-portal search engine, such as for example the Google® web search page. A user may enter a standard search term into this web portal and received a wide variety of search results, including content-related links and content-related advertisements. The accuracy of this information is determined based on the accuracy of the search itself, which may not suit the user's intent.

All politics are local, existing interfacing techniques fail to account accordingly. One existing technique for overcoming the locality of political information is a mash-up application associated with Google® Maps, where political-information is overlaid with links to information listing the elected representatives for the noted regions. This mash-up application is a mere user-friendly linking interface to provide already readily available information, specifically the listing of elected representatives.

Another available resource for election information is the visiting of candidate-specific web pages. It is rare for a political candidate to not have a web site for listing the candidate's information, but there are no standard or general locations for these sites, as well as no standard formatting for the content. This leaves the user searching for election and candidate information to search a very fragmented environment of disparate web sources at disparate web locations. Not only does this increase the difficulty level for users searching for information, it also provides a myriad of additional problems. For example, if the user is not Internet-savvy, the user may have extreme difficulties in finding the sought information. Another problem may be the user misunderstanding who the owner of a web site, visiting a rival candidate's web site instead of the intended candidate's website and being presented with distorted information. Another problem is the difficulty for generating cohesiveness for the user in addressing issues between the candidates, as this may require a significant undertaking of visiting various web locations to determine how candidates feel about particular issues.

There is a great push for improving voter turn-out and engagement of citizens in the electoral process. The emergent medium of the Internet has not evolved to correct the inherent shortcomings of applying existing interfacing techniques to election information. Therefore, in order to make the information more readily available, there exists a need for an interface and architecture for disseminating election information in a user-friendly manner.

### SUMMARY OF THE INVENTION

The present invention provides a method and system for computerized interfacing and dissemination of election-related information. The method and system includes presenting, via a networked connection, a political engagement map that includes a visual interface display of at least one geographic area. The method and system includes receiving a region selection command relative to the political engagement map and retrieving election-specific information associated with a geographic region indicated by the region selection command. The method and system includes updating the political engagement map to display the geographic region and the election-specific information associated with the geographic region and receiving an election information request via a toolbar interface displayed relative to the political engagement map. The method and system includes, in response to the election information request, accessing an election information database to retrieve election information and updating an output display with the retrieved election information.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 illustrates a block diagram of one embodiment of a system for interfacing and dissemination of election-related information;

FIG. 2 illustrates a sample screen shot of an election-related interface display;

FIG. 3 illustrates a flowchart of the steps of one embodiment of a method for interfacing and dissemination of election-related information;

FIG. 4 illustrates a sample screen shot of a political engagement map within an election-related interface display;

FIGS. 5a-5b illustrate sample screen shots of the political engagement maps including selection of a geographic region and related election information;

FIGS. 6a-6c illustrate sample screen shots of searching operations associated with the with political engagement map;

FIG. 7 illustrates a block diagram of another embodiment of a system for interfacing and dissemination of election-related information;

FIG. 8 illustrates a sample screen shot of a featured candidates display;

FIG. 9 illustrates a sample screen shot of an election-specific information news display;

FIG. 10 illustrates a flowchart of the steps of another embodiment of a method for interfacing and dissemination of election-related information; and

FIGS. 11a-11g illustrate sample screen shots of candidate-specific searching operations.

### DETAILED DESCRIPTION OF THE EMBODIMENTS

In the following description, reference is made to the accompanying drawings that form a part hereof, and in which is shown by way of illustration specific embodiments in which the invention may be practiced. It is to be understood that other embodiments may be utilized and design changes may be made without departing from the scope of the present invention.

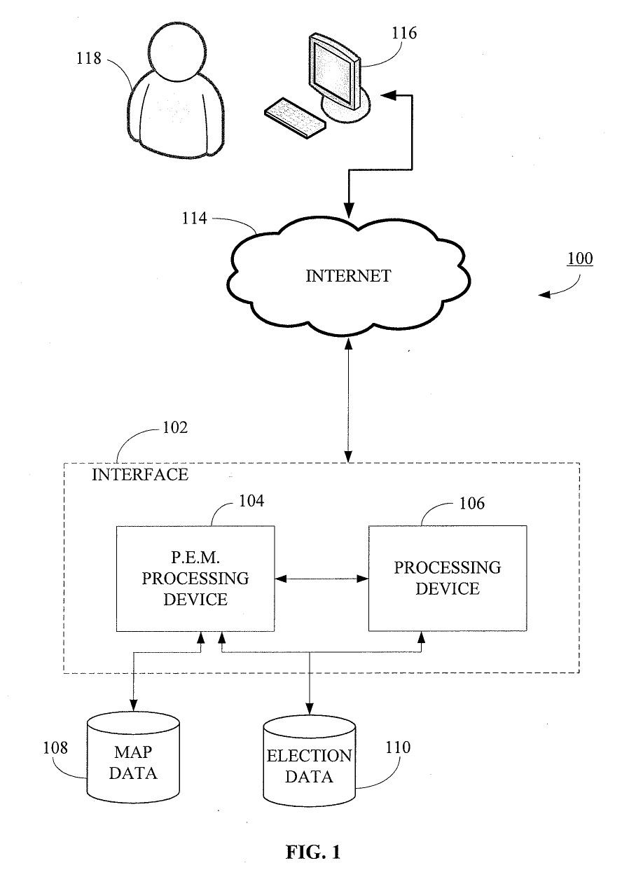

FIG. 1 illustrates one embodiment of a system 100 allowing for interfacing with and engagement of a web-based portal for election-related information. The system 100 includes an interface 102, a political engagement map processing device 104, a processing device 106, a map data database 108, election data database 110. The system 100 illustrated in FIG. 1 further includes a web-based network (Internet) 114, a user computer 116 and a user 118.

The interface 102 is shown generally as including the two processing devices 104 and 106, where it is recognized this device includes any number of additional processing elements recognized by one skilled in the art. The omission of the additional components is for clarity purposes only. For example, the interface includes processing capabilities relating to communication with the Internet 114, where this communication may utilize known communication protocols for data transfer and exchange thereacross.

It is also recognized by one skilled in the art that the interface 102, the political engagement map 104 and the processing device 106 may be physical processing devices operative to perform processing operations in response to executable instructions from one or more computer readable medium. It is also recognized that the processing elements may be hard-wired or hard-coded into the physical processing components. Regardless of the underlying structure, the processing device 104 and 106 may be physical components performing processing operations consistent with the description described herein, including the physical transformation of physical components within the processing device and data manipulation for the performance of the herein described processing operations.

The map data database 108 and the election data database 110 are illustrated as separate storage devices, but it is recognized that it is within the scope of the present invention wherein the databases 108 and 110 may be integrated into one or more combined databases sharing data therein or in another aspect may be distributed across any number of storage locations. Regardless of the physical location of the database 108, and 110, the storage devices are operative store the data therein, and receive data retrieval requests from the interface 102. The data exchange and data structures, as well as processing operations utilizing the data is described in further detail below.

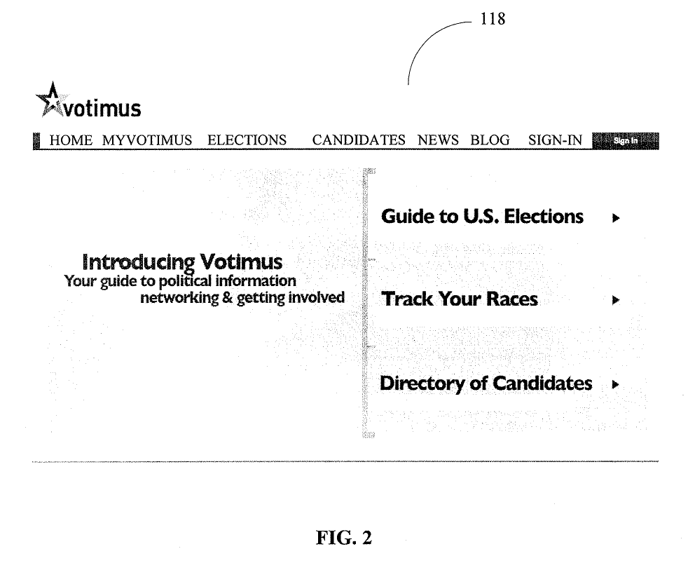

The user 118 is operative to enter data into the computer 116, which engages the interface 102 across the Internet 114, the engagement and communication performed in accordance with known techniques. For example, one embodiment may include the user 118 running a web browser on the computer 116 and accessing the interface 102 via the web portal, such as entering a uniform resource locator (URL) into the web browser. By way of example, FIG. 2 illustrates a sample screen shot 118 of a first web page display for an election-specific interface in accordance with the present invention.

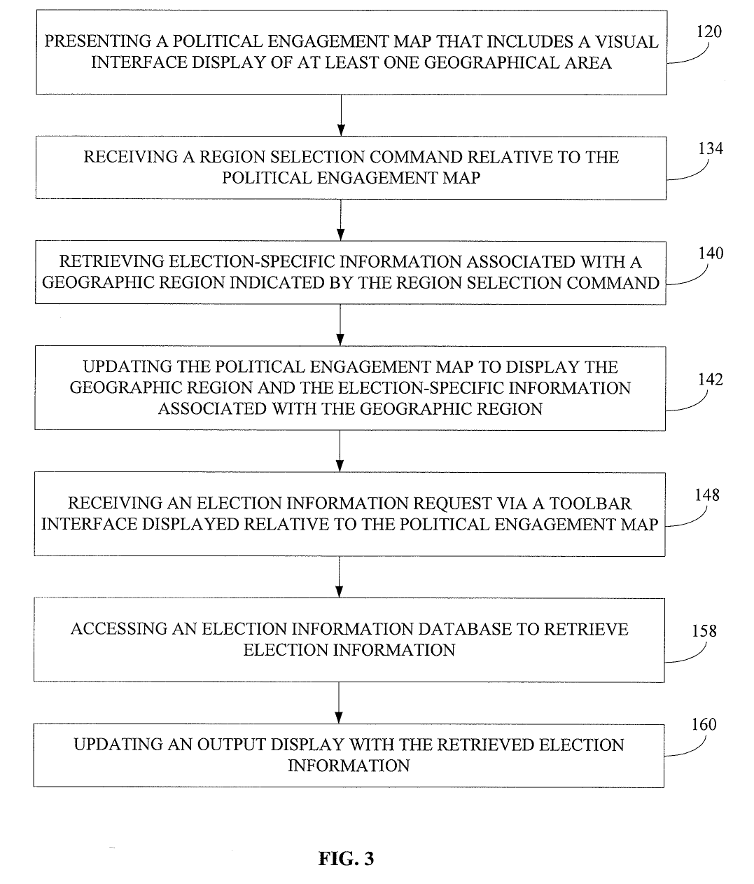

Within the system 100, via the interface 102, the user 118 can receive election-related information. The processing of the interface 102 may be in response to executable instructions from a computer readable medium, wherein the processing devices 104 and 106 are operative to perform the method steps illustrated in FIG. 3.

FIG. 3 illustrates a flowchart of the steps of a method for computerized interfacing and dissemination of election-related information. The method includes presenting a political engagement map that includes a visual interface display of at least one geographical area, step 120. As illustrated in FIG. 1, this presenting of the political engagement map may be displayed on the user computer 116, wherein the map itself is generated by the political engagement map processing device 104. The device 104 utilizes map data from database 108.

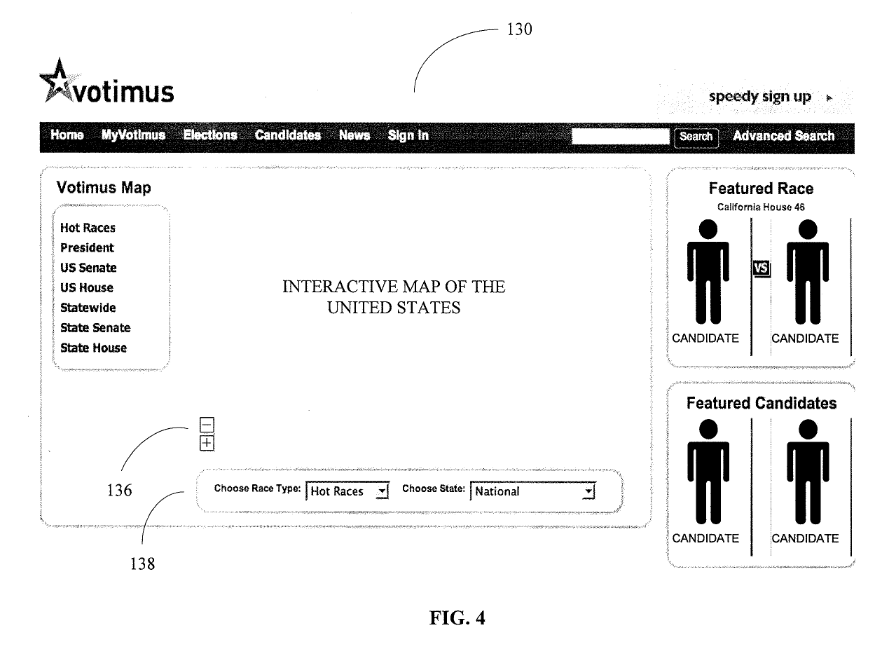

To further illustrate one embodiment of a political engagement map, FIG. 4 illustrates a screen shot 130 including the display of a political engagement map illustrating a display of the full United States of America, each state being visually represented.

Reference back to FIG. 3, a next step in the method is to receive a region selection command, step 134. The receipt of this command may be via the Internet 114 from the user 118 performing an input operation on the computer 116. Referring to the sample screen shot 130 of FIG. 4, this may include selection of a zoom in or out feature 136, could include a selection of one of the states in the map itself, or in another embodiment may include selection of the state pulldown menu 138.

Referring back to FIG. 3, a next step in this embodiment is to retrieve election-specific information associated with a geographic region indicated by the region selection command, step 140. With reference to FIG. 1, this retrieval of election specific information may be performed by the processing device 106 either alone or in combination with the political engagement map processing device 104. The processing device 106 may access the election data database 110 to retrieve the election-specific information. Relative to the region selection command, the election-specific information may include jurisdictional outline information capable of being overlaid with a geographic or regional map, for example showing where a Congressional district is within a particular state.

In FIG. 3, a next step, step 142, is to update the political engagement map to display the geographic region and the election-specific information associated with the geographic region. As illustrated in FIG. 1, the interface 102 may include processing by the political engagement map processing device 104 using data from the map database 108, the processing device performing processing operations in conjunction with the processing device 106 using the election information from the database 110. The interface 102 may thereupon transmit the updated political engagement map to the computer 116 via the Internet 114.

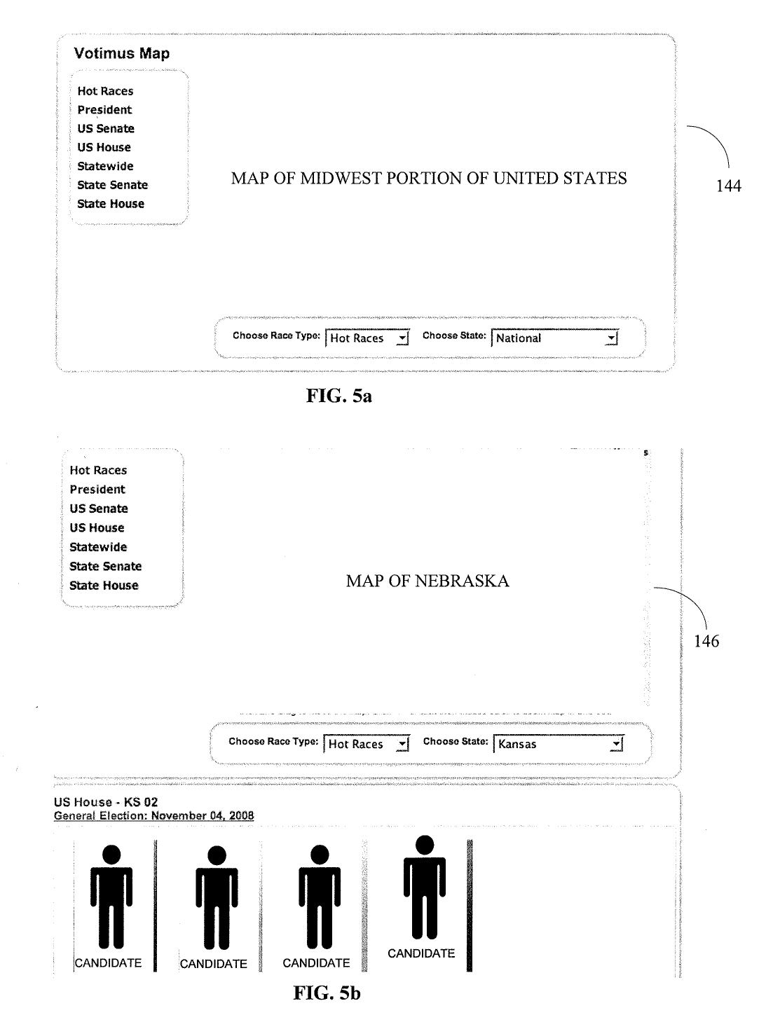

FIG. 5a illustrates an intermediate screen shot 144 showing the zooming in of the display of the political engagement map. In this case, the map is zooming in to the display of the state of Kansas. FIG. 5b illustrates a screenshot 146 including the display of the state of Kansas, as well as the display of a designated race, this example being a General Election to the U.S. House of Representatives. The updating of the political engagement map 146 includes the display, in this embodiment, of the listed candidates as well as pictures, if available. As described in further detail below, the display may be engaged to retrieve additional information, such as selecting the picture may redirect the user to another interface display of personalized information about the candidates.

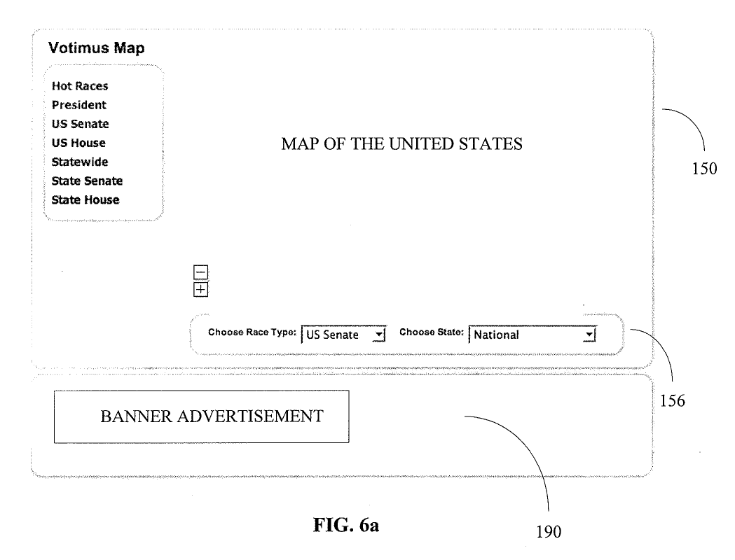

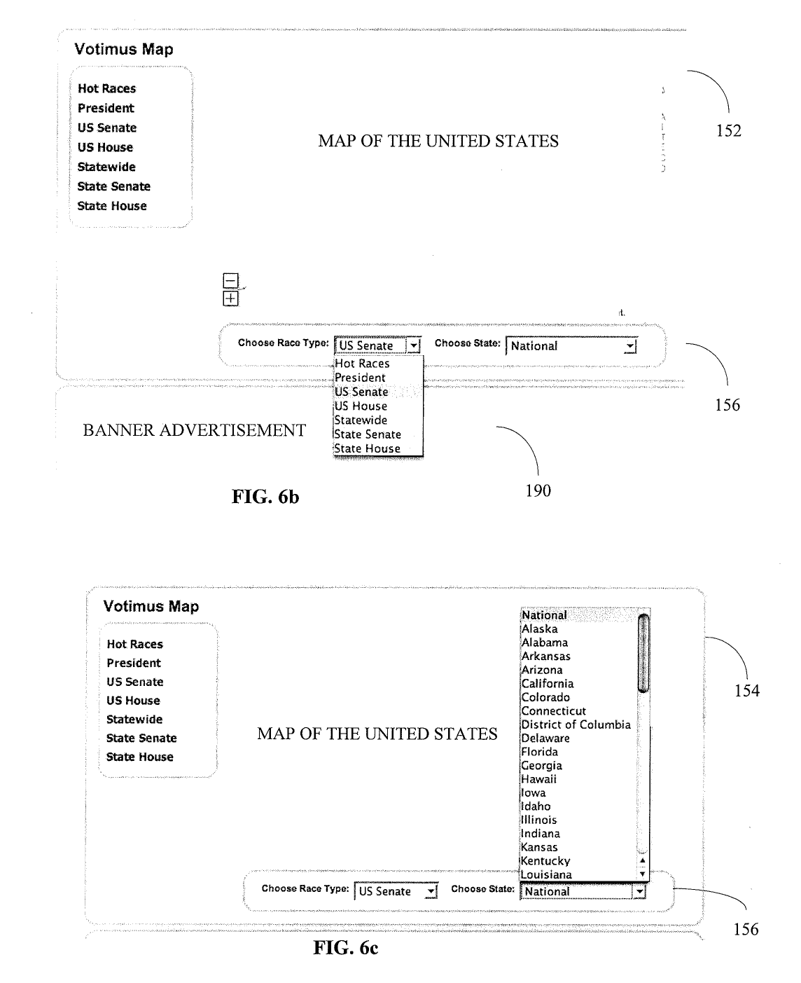

In the method of FIG. 3, step 148 is receiving an election information request via a toolbar interface displayed relative to the political engagement map. FIGS. 6a, 6b and 6c illustrate screen shots 150, 152 and 154, including one embodiment of a toolbar interface 156. In this embodiment, the toolbar interface includes pull down menus that expand upon user selection. The menus include the selection of race type as well as a state.

It is recognized that the pull down menu are not restrictive of the toolbar interface, rather are merely exemplary in nature. The pull down menus provide additional interfacing beyond the user being able to select the displayed race listings adjacent to the political engagement map and then selecting a particular state on the interactive map itself (or in an additional embodiment, zooming in or out and using mouse functions to provide the display of the particular state.)

In this embodiment, an election information request may include choosing a race type, in the example race types of “Hot Race, President, US Senate, US House, Statewide, State Senate, and State House.” A next step, step 158 of FIG. 3, is accessing an election information database to retrieve election information. With reference to FIG. 1, this may include accessing the election data database 110 for the performance of processing operations by the processing device 106. For example, election-specific information may include information about particular elections, candidates, party affiliations, race, religion, gender, issue specific information, as well as any other suitable type of information.

In one embodiment, in FIG. 3, a next step is to update the output display with the retrieved election information 160. Similar to step 142, this may include transmission of an output display to the user computer 116 via the Internet 114. Screenshot 146 of FIG. 5b again illustrates an updated display including the election-specific information displayed on the map, in this embodiment being a display of the state of Kansas, as well as the display of the candidate information in response to the election information request, such as requesting information on the U.S. House race for the state of Kansas.

Thereupon, in this embodiment, the method for computerized interfacing and dissemination of election-related information is complete. In the exemplary interface, the user could request different election information, for example selecting a different race to look at, and the display updates to show information about the newly selected race, for example the candidates for the race.

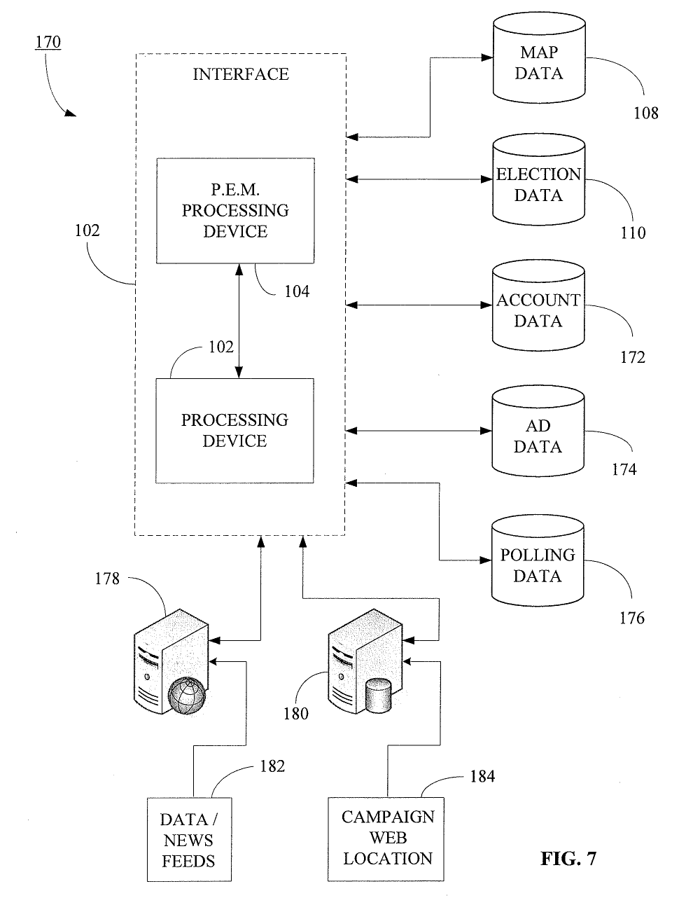

FIG. 7 illustrates another embodiment of a system 170 for computerized interfacing and dissemination of election-related information. The system 170 includes the interface 102, with political engagement map processing device 104 and processing device 106. The system also includes the map data database 108, election data database 1 10, an account data database 172, an advertisement database 174 and a polling data database 176. The system 170 also includes a news feed server 176 and an external political web resource server 180, the news feed server 176 coupled to one or more data/news feeds 182 and the web resource server 180 coupled to any number of campaign/political web locations.

Through the processing device 106, the interface 102 is operative to provide additional processing for the interfacing and dissemination of election-related information. For example, the account data database 172 may include account data relating to various users. Through the account data, users may customize the interface 102. In one embodiment, the interface 102 may recognize a user accessing the visual interface display. Recognition may include recognizing the user through any number of available means, such as a user account login or in another approach using locally stored information, e.g. a cookie, or other informational technique to recognize a user. In response to the user recognition, the processing device 106 may access the user account data database 172 to retrieve user account information that is associated with the user. By way of example, user account data may include listing of the user's political affiliation and location, as well as information regarding the user's stance on various political issues. The user information may also include information from previous activities via the interface, such as selecting particular races to follow, social networking features such as indicating a preference or being in support of various candidates or political movements, by way of example.

Through the interface 102, the personalization of the interface display may include displaying election information related to the user, for example providing a display of the user's preferred candidates or updating the political engagement map to highlight selected political races. Another example of personalization may include providing a display of any new features associated with particular candidates since a user has last visited the interface.

It is recognized that the user may not be a single individual or the user may not be accessing the interface for them individually, but rather may be a group of users. For example, a group of users may be a group of politically-like minded individuals such as a local chapter of a Young Democrats or Young Republican student organization. In another example, the group may be a Political Action Committee (PAC). The user recognition may be similar as described above, including the ability to log into the interface and accessing the account data database 172 in response thereto. The personalization may be relative to the group itself and not focused on the individual user's preference, such as personalization and tracking information may be more directed to objectives of the group and not as focused on the online activity of the user currently accessing the interface. For example, if the user is a PAC, the personalization may be more focused on specific issues as PACs tend to be geared towards political activity associated with election issues.

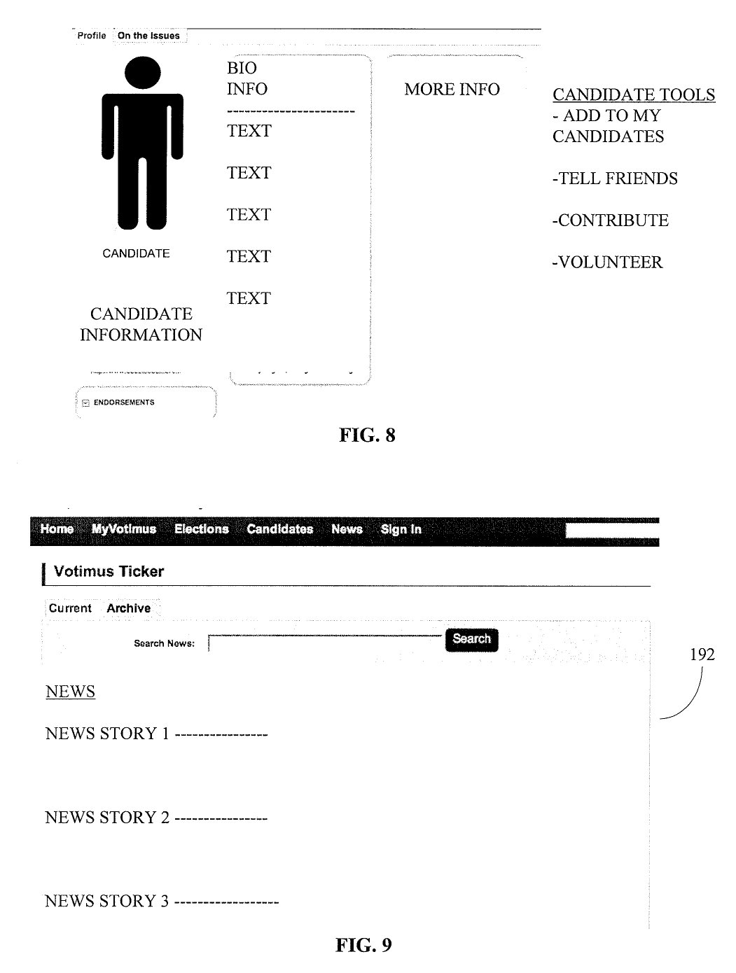

In another embodiment, political candidates can utilize the interface to access and maintain web pages about themselves FIG. 8 illustrates a sample screen shot of a candidate profile page. In the recognition of a user, the user may be the political candidate. Upon accessing the account data database 172 and recognition that the user is a candidate, the interface 102 may be operative to allow the user to update or modify posted information. One example may be a candidate realizing that the interface includes incorrect information about the candidate, so the candidate (user) can log in and update this information. Another example may be where an opponent has added additional information and the candidate (user) also wishes to add information, examples being upcoming campaign stops or positions on new emergent campaign issues.

As illustrated in FIG. 7, there are additional databases accessible by the interface 102, such that the interface is operative to provide additional functionality. For example, the interface may be operative to access the advertising database 174 to retrieve and insert advertising data within the output display. This advertisement may be contextually related to the content of the display when the ad is inserted. In other embodiments, the advertisement may be unrelated to the display content. For example, the screen shot 150 of FIG. 6a illustrates a sample advertisement 190.

Another embodiment includes the insertion of polling data into the interface for one of several different embodiments. A first embodiment is for taking a poll, acquiring information from the user visiting the interface. This may include a standard interface asking the user one or more questions on a particular topic, the interface operative to receive and store the user's answers, as well as calculate a response percentage to the poll questions. In another embodiment, the poll data from the database 176 may relate to displaying polling information to the user, such as informing the user of the results of recent polls. It is recognized that the polling information does not have to be local to the interface, but could be received from additional sources, such as a Gallup® poll, by way of example.

The servers 178 and 180 coupled to the interface 102 additionally allow further information to be presented. The data/news feed server 178 is coupled to receive any number of news feeds 182 for inclusion in the interface. The server 178 may receive any incoming news feed and filter the information or may be directed to receive election-specific data/news feeds. As used herein data feeds generally refer to opinion-related content, for example partisan web logs and news feeds refer to recognized news organization feeds, for example New York Times, Washington Post, etc. The feeds may be direct data feeds via a Really Simply Syndication (RSS) feed, may be pushed data consistent with a subscription agreement or any other type of feed providing the associated content.

The server 178 is operative to receive and forward the feeds to the interface 102, whereby the interface can utilize the news/data content in any suitable manner. For example, one technique is to filter the news/data content consistent with a user's content information and only display relevant information to the user. Another embodiment is to provide all the news/data feeds in an unfiltered fashion, allowing the user to select the desired content.

FIG. 9 illustrates a sample screen shot 192 of a ticker illustrating recently received new articles. The content is provided via the interface, in this embodiment in a separate interface display specific to the particular user. This interface display includes a list of the article title, a brief abstract, when it was posted and the election to which it relates. Again, this exemplary embodiment is personalized to the particular user, providing direct content relevant to the areas of interest.

The web server 180 also provides the interface the availability for external content 184 relating to the election-specific information. As noted in the background section, it is rare for a political candidate to not have a web presence, and this web presence provides an additional wealth of information about the candidate. The interface 102 of FIG. 7 provides, via the web server 180, access to this additional information.

Candidate specific web pages may be logged into the web server 180, either by the candidate themselves or by supporters tracking this information. The web location is then made available via the interface 102 such that when the user accesses the candidate information, the user can additionally access the external information. This information may be displayed in a nested format (e.g. embedded within the existing interface) or may be displayed in a browser window (e.g. external to the interface itself). Therefore, through the web server 180, candidate generated web content is incorporated in the interface 102.

It is recognized by one skilled in the art that there exists additional data interchanges available via the interface and the illustrated embodiments of FIG. 7 are not an exhaustive and restrictive list. For example, another embodiment may include accessing a web location via the interface for a user to sign-up for or volunteer for a particular activity. Another embodiment may include a user donating money to a candidate or a political cause. Another embodiment may include a user electronically sending an invitation to a friend to access the interface to read up on a candidate or issue and pledge support. There are additional embodiments for additional interactivity with the interface, as recognized by one skilled in the art.

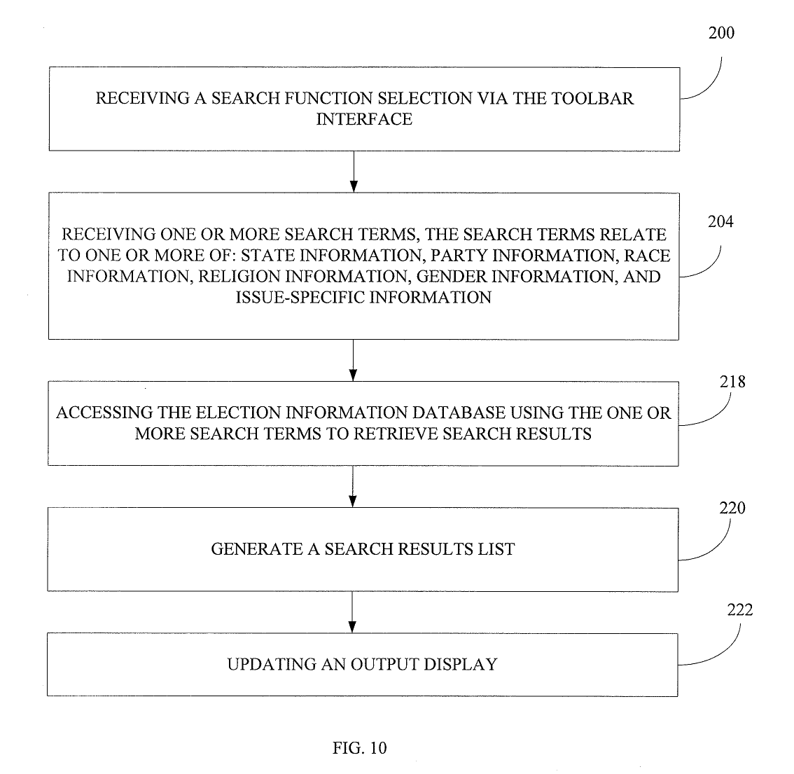

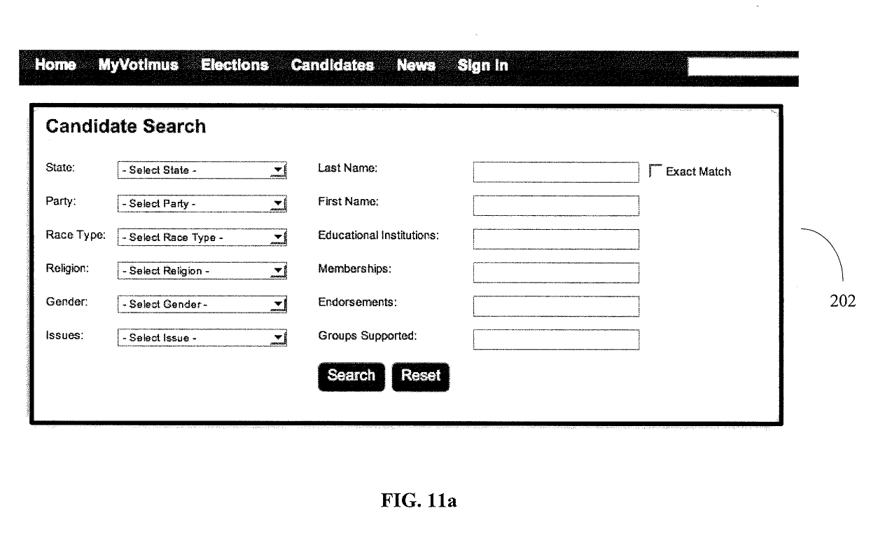

FIG. 10 illustrates a flowchart of the steps on one embodiment of a method for interfacing and dissemination of election information including search functionality. As noted above, the processing of election-specific information includes additional factors relating to the handling and processing of the data based on the nature of election-specific information. As noted in the background section, existing searching techniques are ill-suited to handle the searching requirements for searching political information.

The method of FIG. 10 includes receiving a search function selection via a toolbar interface. For example, in the screen shot 130 of FIG. 4, the tool bar includes an “advance search” function, which may be an active link to a search interface. FIG. 1 la illustrates a sample screen shot 202 of an election-specific searching interface.

The method of FIG. 10 includes, step 204, receiving one or more search terms, the search terms relating to one or more of the following: state information, party information, race information, religion information, gender information, issue-specific information, name, educational background information, membership information, endorsement information and/or groups supported. In this exemplary interface, the user may enter information into various data entry fields or select pull down menus where available.

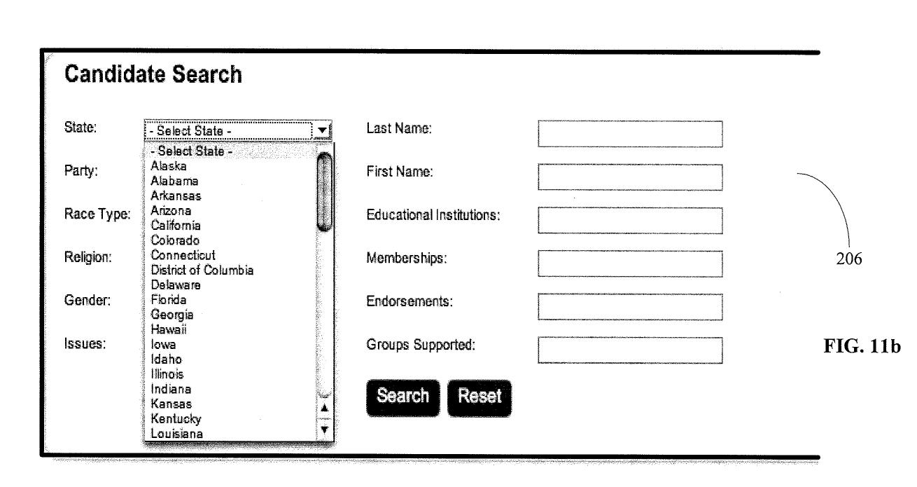

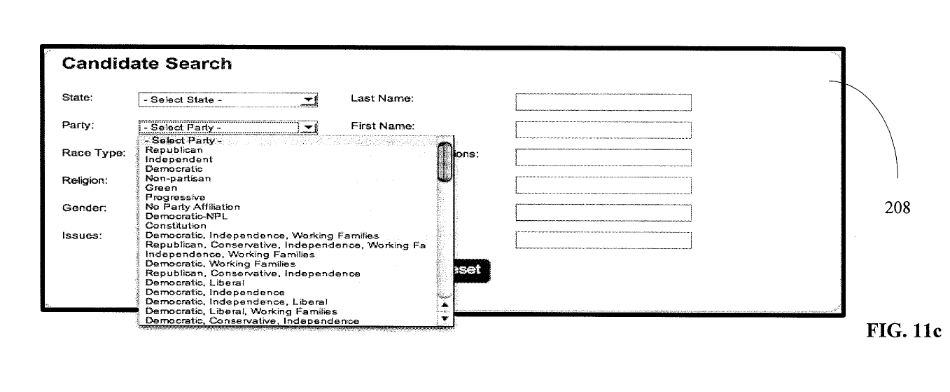

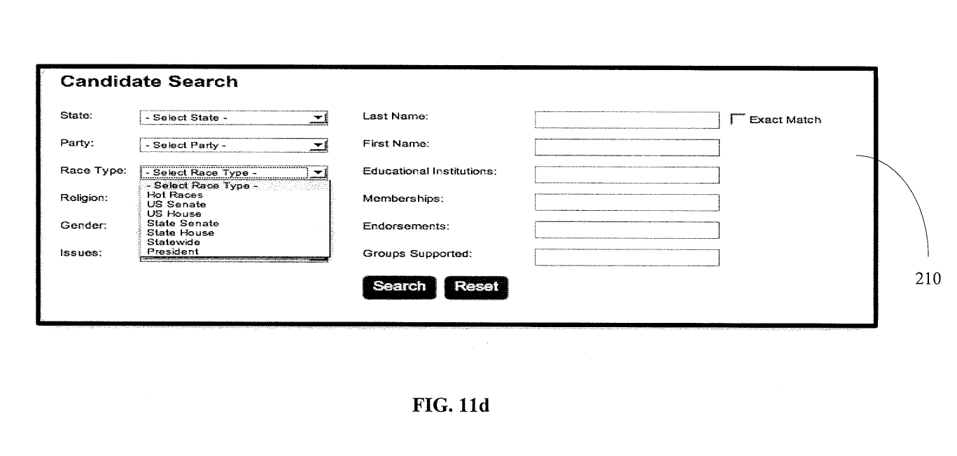

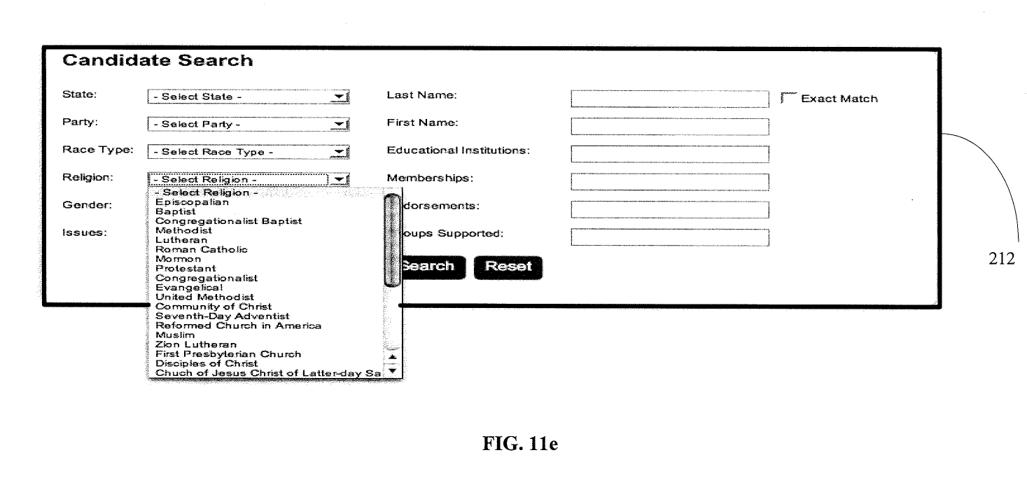

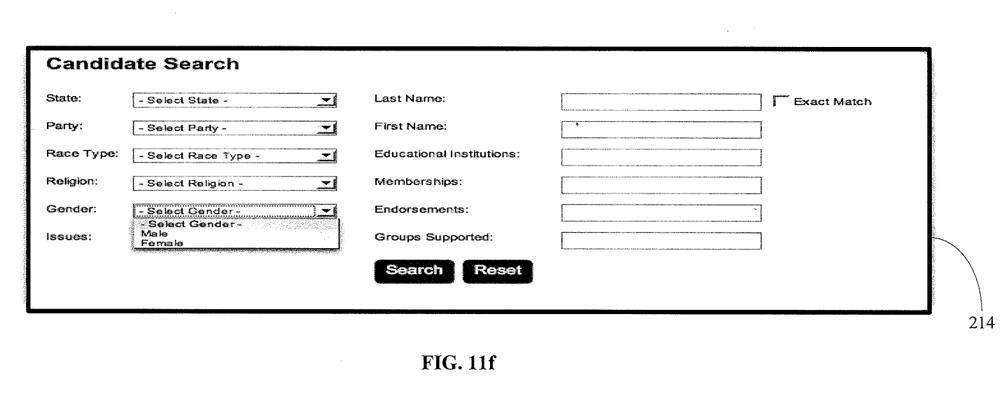

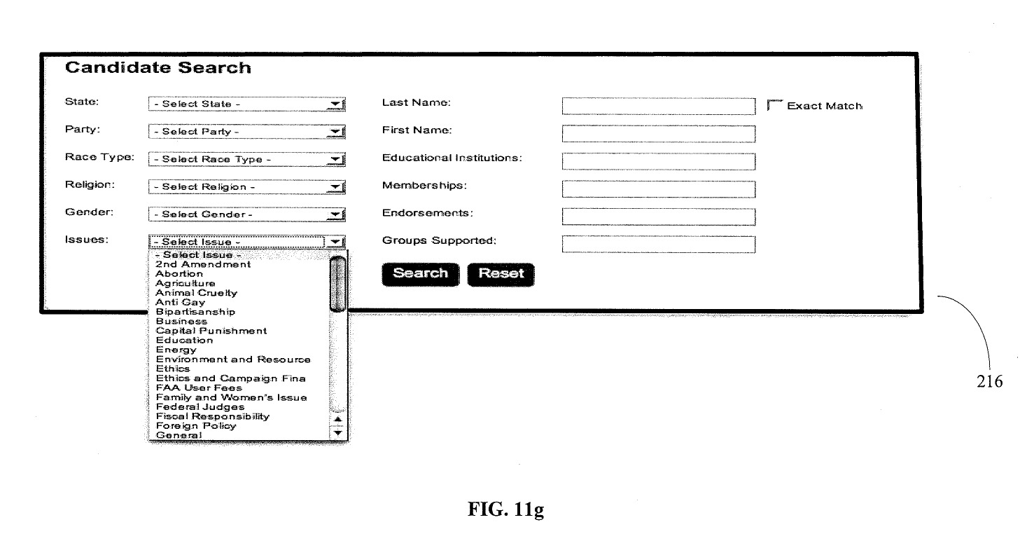

FIGS. 11b-11g illustrates various exemplary screen shots 206-216 for pull down menu search options. It is noted that in addition to the pull down menu search options, there are also data entry field options.

With reference back to FIG. 10, a next step, step 218, is accessing the election information database using the search terms to retrieve search results. In one embodiment, the election information may be categorized in the database in a format consistent with the search inputs. The searching the database may be performed using known data searching techniques.

A next step, step 220, is to generate a search results list and update the output display, step 222. Thereby, the user can perform election-specific searching operations in the election data database (110 of FIGS. 1 and 7), where this additional information is presentable through the interface.

Accordingly, through the above-described method and system for interfacing and disseminating election-related information, users are presented with ready access to the plethora of information in a convenient and easy to use format. Through the inclusion of the toolbar interface and the political engagement map, users are presented with direct access to the election-related information via the centralized platform, as well as the inclusion of various additional interfacing options for election-related information, including user personalization of the interface, searching operations, advertising, polling information, donation and volunteering interfaces, among others. The method and system provides ready access to the information in a user-friendly manner overcoming the arcane access to this information by existing web-interfacing techniques, and thereby making information more accessible and hence informed voting by concerned citizens more readily available.

FIGS. 1 through 11 are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments so fully reveals the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

What is claimed is:

1. A method for computerized interfacing and dissemination of election-related information, the method comprising:
presenting, via a networked connection, a political engagement map that includes a visual interface display of at least one geographic area;
receiving a region selection command relative to the political engagement map;
retrieving election-specific information associated with a geographic region indicated by the region selection command;
updating the political engagement map to display the geographic region and the election-specific information associated with the geographic region;
receiving an election information request via a toolbar interface displayed relative to the political engagement map;
in response to the election information request, accessing an election information database to retrieve election information; and
updating an output display with the retrieved election information.

2. The method of claim 1 further comprising:
recognizing a user accessing the visual interface display;
accessing a user account database having user account information associated with the user; and
personalizing the output display based on the user account information.

3. The method of claim 2, wherein the user is an individual and personalizing comprises displaying election information related to the user.

4. The method of claim 2, wherein the user is a group of user and personalizing comprises displaying election information related to the group of users.

5. The method of claim 4, wherein the group of users is a political action committee.

6. The method of claim 2, wherein the user is an election candidate and personalizing comprises displaying an input interface such that the candidate may update election information attributed to the candidate.

7. The method of claim 1, wherein the geographic area includes the United States of America and the geographic region includes a state within the United States of America.

8. The method of claim 1 further comprising:
receiving a search function selection via the toolbar interface;
receiving at least one search terms;
accessing the election information database using the least one search terms to retrieve search results; and
providing an output display of the search results.

9. The method of claim 8, wherein the search function includes search terms relating to at least one of: state information, party information, race information, religion information, gender information, issue-specific information, name information, educational information, membership information, endorsement information and information relating to groups that are supported.

10. The method of claim 1 further comprising:
requesting a political donation via a donation interface.

11. The method of claim 1 further comprising:
inserting and displaying an advertisement in the output display.

12. The method of claim 1 further comprising:
receiving political volunteer requests via a volunteer sign-up interface.

13. The method of claim 1 further comprising:
receiving polling input information via a polling interface.

14. The method of claim 1 further comprising:
receiving a plurality of political content from at least one new feeds;
aggregating the political content based on a plurality of content factors; and
displaying the aggregated political content via the output display.

15. A system for computerized interfacing and dissemination of election-related information, the system comprising:
a computer readable medium having executable instructions stored therein;
an election information database; and
a processing device in communication with the computer readable medium and the election information database, the processing device receiving the executable instructions from the computer readable medium, the processing device, in response to the executable instructions, operative to:
present, via a networked connection, a political engagement map that includes a visual interface display of at least one geographic area;
receive a region selection command relative to the political engagement map;
retrieve election-specific information associated with a geographic region indicated by the region selection command;
update the political engagement map to display the geographic region and the election-specific information associated with the geographic region;
receive an election information request via a toolbar interface displayed relative to the political engagement map;
in response to the election information request, access the election information database to retrieve election information; and
update an output display with the retrieved election information.

16. The system of claim 15 further comprising:
a user account database; and
the processing device, in response to the executable instructions, further operative to:
recognize a user accessing the visual interface display;
access a user account database having user account information associated with the user; and
personalize the output display based on the user account information.

17. The system of claim 16, wherein the user is an individual and personalizing comprises displaying election information related to the user.

18. The system of claim 16, wherein the user is a group of user and personalizing comprises displaying election information related to the group of users.

19. The system of claim 16, wherein the user is an election candidate and personalizing comprises displaying an input interface such that the candidate may update election information attributed to the candidate.

20. The system of claim 15, wherein the processing device, in response to the executable instructions, is further operative to:
receive a search function selection via the toolbar interface;
receive at least one search terms;
access the election information database using the least one search terms to retrieve search results; and
provide an output display of the search results.

21. The system of claim 20, wherein the search function includes search terms relating to at least one of: state information, party information, race information, religion information, gender information, issue-specific information, name information, educational information, membership information, endorsement information and information relating to groups that are supported.
